(19) United States
(12) Patent Application Publication
(10) Pub. No.: US 2009/0157496 A1
(43) Pub. Date: Jun. 18, 2009

(54) PERSONAL BROADCAST ENGINE AND NETWORK

(75) Inventors: Marc E. Davis, San Francisco, CA (US); Ronald G. Martinez, San Francisco, CA (US); Christopher W. Higgins, Portland, OR (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 11/957,052

(22) Filed: Dec. 14, 2007

(51) Int. Cl. G06Q 99/00; G01C 21/00; G06Q 30/00

(52) U.S. Cl. 705/14; 701/300; 705/1

(57) ABSTRACT

A personal broadcasting system and method is described herein for automatically matching and introducing users based on their real-time locations, such that users identified as capable of or likely to form a relationship can be notified of that fact at a point in time when it is easy to meet. A system and method is also described herein that allows at least one of two users that have visited or passed through the same location at different points in time to automatically receive information about the other despite the temporal separation between them.

### BACKGROUND OF THE INVENTION

1. Field of the Invention

The present invention relates to systems and methods for automatically matching and introducing users for the purpose of establishing and building relationships, including but not limited to social and commercial relationships.

2. Background

It is often difficult for a person seeking to establish a social relationship (e.g., a person looking for a dating partner) to meet others who are good candidates for such a relationship. One method of meeting such people is to rely on word-of-mouth recommendations from existing social relations, such as from friends and family. However, this approach can limit the number of opportunities for meeting new people, particularly where one's social network is small. Moreover, such recommendations may actually be based on the preferences of the person making the recommendation rather than the person seeking a relationship, thus resulting in a poor match.

Meeting people outside of one's social network may also be difficult. Often, time must first be spent trying to identify a venue in which such a person may be found. For example, a person seeking to meet a dating partner may first need to identify a location or event that is likely to attract a person sharing a common interest or characteristic. Upon meeting someone in such a venue, time must be spent conversing with and getting to know that person to determine whether or not that person is a good match. This can be awkward, time-consuming and, depending on the person met, ultimately unproductive.

Thus, more efficient and productive methods for meeting candidates for social relationships are needed. For example, as a person moves about during the course of a day, he or she may come into contact with or within proximity of any number of potential candidates for a social relationship. It would be beneficial if a system existed that allowed the person to automatically receive information from and/or exchange information with closely-located candidates in real-time to determine whether an introduction would be worthwhile. Such a system could advantageously eliminate the need for the awkward introductions and the lengthy conversation necessary to meet a person and determine if he/she is a good match. Additionally, such a system could advantageously enable highly-compatible people to be made aware of each other at a time when it is easiest for them to meet. Unfortunately, such a system does not presently exist.

Furthermore, it is conceivable that two people who are well-matched may visit or pass through the same location but at different points in time. It would be beneficial if a system existed that allowed at least one of the two people to automatically receive information about the other despite the temporal separation between them. Such a system could advantageously connect these people, whereas in the past they would never meet. Unfortunately, such a system also does not exist.

Dating services exist that match users by analyzing explicitly-provided user profile information. However, these services do not allow for a real-time synchronous or asynchronous exchange of information among users based on spatial proximity, either at the same time or different times, as discussed above. Such dating services also do not perform matching in a manner that truly leverages the totality of information that may be available about a particular user.

For example, as personal electronic devices (e.g., cellular telephones, handheld computing devices, personal digital assistants, portable media players and handheld game consoles) proliferate, they effectively create a distributed sensor network that is capable of gathering data about the preferences, interests and actions of users. A correlation of disparate facts obtained from such a network can reveal patterns or answer such complex questions such as “will I like this person.” To date, however, no one has been able to harness this power to facilitate the matching and introduction of users for the purpose of establishing and building social relationships.

The foregoing problems are not relevant only to meeting dating partners, but also to meeting other types of people with whom one wishes to interact socially, including but not limited to potential friends, professional contacts, or special interest group members. Furthermore, the foregoing problems also apply to meeting people with whom one wishes to do business.

For example, it is often difficult to find suitable employers, employees, business partners, vendors, customers, and service providers. It would be beneficial if a system existed that provided a real-time introduction and screening service among users that have just met or are able to meet that could facilitate the formation of all types of relationships, including but not limited to social and commercial relationships.

### BRIEF SUMMARY OF THE INVENTION

A personal broadcasting system and method is described herein for automatically matching and introducing users based on their real-time locations, such that users identified as capable of or likely to form a relationship can be notified of that fact at a point in time when it is easy to meet. A system and method is also described herein that allows at least one of two users that have visited or passed through the same location at different points in time to automatically receive information about the other despite the temporal separation between them. Certain implementations of the present invention advantageously eliminate the need for awkward introductions and lengthy conversations necessary to meet a person and determine if he/she is a good match. Additionally, certain implementations of the present invention enable highly-compatible people to be made aware of each other at a time when it is easiest for them to meet.

In particular, a method for matching and introducing users is described herein. In accordance with the method, a determination is made as to whether a first user and a second user are within a predefined distance of each other based on real-time location information associated with the first user and the second user. Responsive to a determination that the first user and the second user are within a predefined distance of each other, a determination is made as to whether the first user is eligible to transmit a personal broadcast to the second user. The personal broadcast may be, for example, one of a user profile, a business card, a classified advertisement, a personals advertisement, a resume or a help wanted posting. Responsive to a determination that the first user is eligible to transmit a personal broadcast to the second user, a personal broadcast associated with the first user is transmitted to a user device associated with the second user over a network.

In accordance with the foregoing method, determining if the first user is eligible to transmit a personal broadcast to the second user may include comparing user data associated with the first user and user data associated with the second user, wherein the user data comprises one or more of spatial, temporal, social or topical data associated with each user. Determining if the first user is eligible to transmit a personal broadcast to the second user may additionally or alternatively include accessing permissioning rules associated with the first and/or second user.

The foregoing method may further include obtaining the location-tracking information associated with the first user and the second user by tracking the location of a user device associated with the first user and the user device associated with the second user.

The foregoing method may still further include inserting dynamic content within the personal broadcast prior to transmitting the personal broadcast. Such dynamic content may be programmatically-determined based on one or more conditions associated with the transmission of the personal broadcast from the first user to the second user. Such dynamic content may include an advertisement or sponsored content associated with the personal broadcast.

The foregoing method may additionally include receiving a personal broadcast associated with the second user by a user device associated with a first user over the network.

A system for for matching and introducing users is also described herein. The system includes a matching manager and a personal broadcast exchange manager communicatively connected to the matching manager. The matching manager is configured to determine that a first user and a second user are within a predefined distance of each other based on real-time location information associated with the first user and the second user and, responsive to determining that the first user and the second user are within a predefined distance of each other, to determine if the first user is eligible to transmit a personal broadcast to the second user. The personal broadcast exchange manager is configured to transmit a personal broadcast associated with the first user to a user device associated with the second user over a network responsive to a determination that the first user is eligible to transmit a personal broadcast to the second user.

In accordance with the foregoing system, the matching manager may be configured to determine if the first user is eligible to transmit a personal broadcast to the second user by comparing user data associated with the first user and user data associated with the second user, wherein the user data comprises one or more of spatial, temporal, social or topical data associated with each user. Alternatively or additionally, the matching manager may be configured to determine if the first user is eligible to transmit a personal broadcast to the second user by accessing permissioning rules associated with the first and/or second user. The matching manager may be further configured to obtain the location-tracking information associated with the first user and the second user by tracking the location of a user device associated with the first user and the user device associated with the second user.

In further accordance with the foregoing system, the personal broadcast exchange manager may be further configured to insert dynamic content within the personal broadcast prior to transmitting the personal broadcast, wherein the dynamic content is programmatically-determined based on one or more conditions associated with the transmission of the personal broadcast from the first user to the second user. The dynamic content may include an advertisement or sponsored content associated with the personal broadcast.

The foregoing system may further comprise a personal broadcast manager configured to permit a remote user to select and/or generate content associated with a personal broadcast.

An alternative method for matching and introducing users is also described herein. In accordance with this method, a personal broadcast associated with a first user is transmitted to a network node responsive to a determination that the first user has entered a predefined area around the network node. The personal broadcast is stored locally with respect to the network node. The personal broadcast is then transmitted from the network node to a user device associated with a second user responsive to determination that the second user has entered the predefined area around the network node. The second transmitting step occurs after the first user has left the predefined area around the network node.

The foregoing method may further include determining if the second user is eligible to receive the personal broadcast. Determining if the second user is eligible to receive the personal broadcast may include comparing user data associated with the first user and user data associated with the second user, wherein the user data comprises one or more of spatial, temporal, social or topical data associated with each user. Determining if the second user is eligible to receive the personal broadcast may alternatively or additionally include accessing permissioning rules associated with the first and/or second user.

An alternative system for matching and introducing users is also described herein. The system includes a personal broadcast engine and a network node communicatively connected to the personal broadcast engine. The personal broadcast engine is configured to transmit a personal broadcast associated with a first user to the network node responsive to determining that the first user has entered a predefined area around the network node. The network node is configured to store the personal broadcast and to subsequently transmit the personal broadcast to a user device associated with a second user responsive to determining that the second user has entered the predefined area around the network node.

In accordance with the foregoing system, the network node may be further configured to determine if the second user is eligible to receive the personal broadcast. The network node may be configured to determine if the second user is eligible to receive the personal broadcast by comparing user data associated with the first user and user data associated with the second user, wherein the user data comprises one or more of spatial, temporal, social or topical data associated with each user. Alternatively or additionally, the network node may be configured to determine if the second user is eligible to receive the personal broadcast by accessing permissioning rules associated with the first and/or second user.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a high-level block diagram of a system for automatically matching and introducing users in accordance with an embodiment of the present invention.

FIG. 2 is a block diagram of a personal broadcast engine in accordance with an embodiment of the present invention.

FIG. 3 illustrates different types of user data that may be used to match users to each other for the purpose of transmitting and/or receiving personal broadcasts in accordance with an embodiment of the present invention.

FIG. 4 depicts a flowchart of a method for automatically matching and introducing users in accordance with an embodiment of the present invention.

FIG. 5 is a block diagram of a system for transmitting a personal broadcast from a personal broadcast engine to a user device in accordance with one embodiment of the present invention.

FIG. 6 is a block diagram of a system for transmitting a personal broadcast from a first user device to a second user device in accordance with an embodiment of the present invention.

FIG. 7 is a conceptual representation of a manner in which personal broadcasts may be transmitted between proximally-located users in accordance with an embodiment of the present invention.

FIG. 8 is a conceptual representation of a manner in which exchange clouds may be formed between proximally-located users in accordance with an embodiment of the present invention.

FIG. 9 is a conceptual representation of a manner in which users may be rendered selectively visible to each other for the purposes of personal broadcasting in accordance with an embodiment of the present invention.

FIG. 10 depicts a flowchart of a method for allowing at least one of two users passing through the same location to automatically receive personal broadcast information about the other despite a temporal separation between them.

FIGS. 11 and 12 are block diagrams of a system in accordance with an embodiment of the present invention that includes a network node configured to receive and store personal broadcasts from a first user for later transmission to a second user.

FIG. 13 is a block diagram of system in accordance with an embodiment of the present invention in which a network node is used to automatically create exchange clouds among all users registered with or detected by the network node.

FIG. 14 depicts a flowchart of a method for asynchronously reporting information to a first user about other users that the first user encounters or comes into contact with.

FIG. 15 is a block diagram of an example computer system that may be used to implement aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Example System Architecture

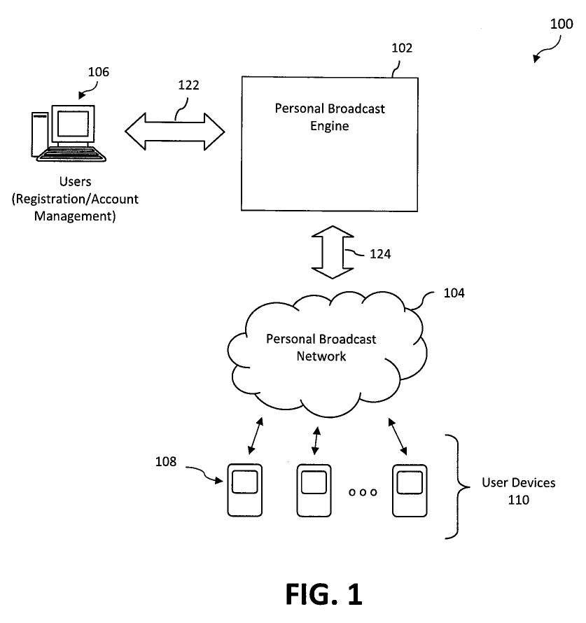

FIG. 1 is a high-level block diagram of an exemplary system 100 for automatically matching and introducing users in accordance with an embodiment of the present invention. As shown in FIG. 1, system 100 includes a personal broadcast engine 102 that is communicatively connected to users 106 via a first interface 122 and to a personal broadcast network 104 via a second interface 124. Each of the elements of system 100 will now be briefly described, with additional details to be provided in subsequent sections.

First interface 122 is configured to allow users 106 to interact with personal broadcast engine 102 to register for participation in personal broadcasting as facilitated by personal broadcast engine 102 and personal broadcast network 104. First interface 122 is further configured to allow a user to perform certain account management function such as the selection and/or creation of content to be included in personal broadcasts and the specification of parameters that will govern what type of personal broadcast information will be transmitted or received by the user and the conditions under which such communication may occur. In one embodiment of the present invention, first interface 122 comprises an application programming interface (API) that can be used to build applications by which user systems/devices can interact with personal broadcast engine 102, although the invention is not so limited.

Personal broadcast engine 102 is a system that is configured to receive personal broadcast information from users, to perform real-time matching of users to other users based on at least spatial proximity, and to facilitate the transmission, reception or exchange of personal broadcast information between and among the users based on the matching function. As will be discussed in more detail herein, the matching function may also be based on a variety of spatial, temporal, social and/or topical information associated with each of the users. Personal broadcast engine 102 may be further configured to control and/or monitor the ongoing exchange of personal broadcast information between users, thereby facilitating multi-stage user interactions.

Personal broadcast information is received by a user via a user device 108. User device 108 may comprise any type of processor-based user device, including but not limited to a laptop computer, cellular phone, personal digital assistant, portable media player, or the like. As shown in FIG. 1, a plurality of such user devices 110 are communicatively connected to personal broadcast engine 102 via a personal broadcast network 104. As will be appreciated by persons skilled in the relevant art(s), personal broadcast network 104 may comprise any type of network or combination of networks capable of facilitating the communication of data between personal broadcast engine 102 and user devices 110 and, optionally, among user devices 110.

Personal broadcast engine 102 is configured to use personal broadcast network 104 to facilitate the transmission of personal broadcast information to users via their user devices 110. Personal broadcast engine 102 may also be configured to use personal broadcast network 104 to determine the real-time location of users and to match users based on at least this location information. Communication between personal broadcast engine 102 and personal broadcast network 104 takes place over second interface 124. In one embodiment of the present invention, second interface 124 comprises an API that can be used to build applications by which personal broadcast engine 102 can communicate with user devices 110, although the invention is not so limited.

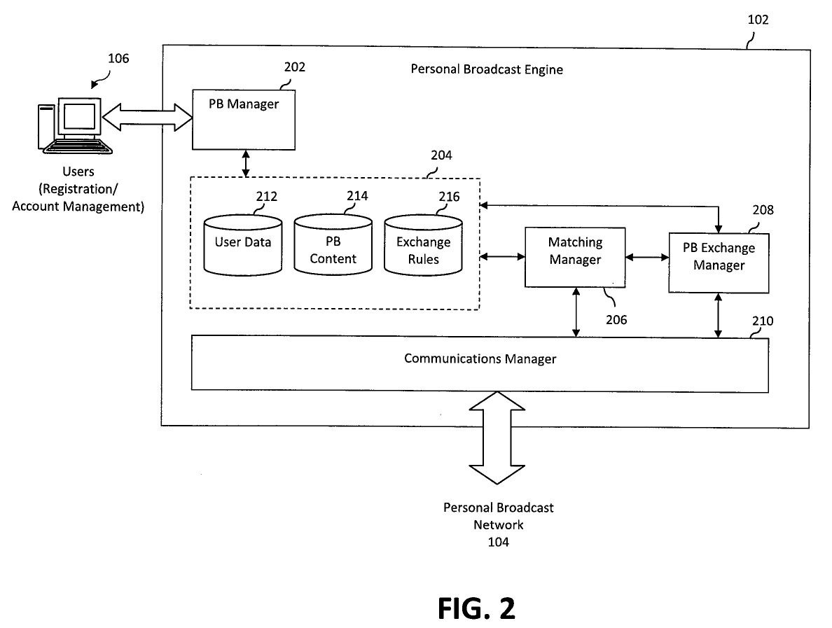

FIG. 2 depicts personal broadcast engine 102 in more detail. As shown in FIG. 2, personal broadcast engine 102 includes a number of communicatively-connected elements including a personal broadcast (PB) manager 202, a plurality of databases 204 (including a user data database 212, a PB content database 214 and an exchange rules database 216), a matching manager 206, a PB exchange manager 208, and a communications manager 210. Each of these elements will now be described.

### 1. PB Manager

PB manager 202 is a component that is configured to allow a user to interact with personal broadcast engine 102 from a remote location to perform a variety of functions, including registering for participation in personal broadcasting, selecting and/or creating content to be included in personal broadcasts, and specifying parameters that will govern what type of personal broadcast information will be transmitted and/or received by a user and under what conditions such communication may occur. In one implementation, PB manager 202 is implemented using a Web service and a standard set of Web APIs for utilizing the Web service. Web applications built upon the Web service may be published by an entity that owns and/or operates personal broadcast engine 102 or by other entities. Such Web applications are accessed by users using Web browsers in a well-known fashion.

The system or device used by a user to interact with PB manager 202 may be any one of user devices 110 or some other system or device. In one embodiment, communication between users and PB manager 202 occurs over the Internet. However, the invention is not so limited, and communication between users and PB manager 202 may occur over any type of network or combination of networks including wide area networks, local area networks, private networks, public networks, packet networks, circuit-switched networks, and wired or wireless networks.

As noted above, PB manager 202 allows a user to select and/or create content to be included in a personal broadcast. This content is then stored by PB manager 202 in PB content database 214. Depending upon the implementation, the content may include any information that a user wishes to share with other users. For example, and without limitation, the content may comprise a user profile or user information, business card, classified advertisement, personal advertisement, resume, help wanted posting, or the like. The content may also comprise one or more text, graphic, audio and/or video components. In one implementation, the content is embodied in a Web page that is viewable on any of user devices 110.

The content may also include both static and dynamic content. The dynamic content may be programmatically determined at the time of broadcast to another user by PB exchange manager 208. For example, such dynamic content may be programmatically determined based on the context of a personal broadcast, the subject matter of the personal broadcast, the relationship of the user to other users, the device or network conditions, or other conditions present at the time of transmission of a personal broadcast. This determination may take into account one or more spatial, temporal, social or topical parameters associated with the broadcasting user, the user(s) receiving the broadcast, or both. In one embodiment, the dynamic content comprises an advertisement or sponsored content associated with the personal broadcast. The content may also comprise links to other network-accessible content, including monetized links that may be used to permit an advertiser to sponsor a specific personal broadcast. Such links may be static or dynamic ally-generated.

In one implementation, a user may select and/or create content for multiple personal broadcasts, or may select and/or create one or more personal broadcasts, each of which includes multiple parts. For example, a user may create different personal broadcasts or broadcast parts that are uniquely associated with a different alias, role, personality or mood of the user.

As also noted above, PB manager 202 allows a user to specify parameters that will govern what type of personal broadcast information will be transmitted or received by a user and under what conditions such communication may occur. This information is stored by PB manager 202 in exchange rules database 216.

For example, a user may specify that he/she is interested in transmitting personal broadcasts only or receiving personal broadcasts only. A user may also specify quantitative parameters relating to the number of personal broadcasts to transmit or receive, including but not limited to parameters relating to the frequency and amount of personal broadcasts to be transmitted and received. A user may further specify temporal and spatial parameters relating to when and where personal broadcasts should be transmitted and received.

In one implementation, a user can specify which types of personal broadcasts he/she is interested in receiving based on, for example, the origin and/or content of personal broadcasts. The user can also specify parameters concerning which users should be targeted for the transmission of personal broadcasts.

As noted above, a user may select and/or create content for multiple personal broadcasts or may create one or more personal broadcasts, each of which includes multiple parts. In one embodiment of the present invention, each of the personal broadcasts or personal broadcast parts may or may not be eligible for transmission to another user depending upon parameters explicitly provided by a user via PB manager 202. Additionally or alternatively, the determination of which of the personal broadcasts or personal broadcast parts are eligible for transmission to another user may be made based upon one or more contextual factors, including but not limited to spatial, temporal, social or topical information associated with the transmitting user and/or receiving user.

In one implementation, control over which personal broadcasts, personal broadcast parts, or specific personal broadcast information is transmitted to or received from a particular user at a given point in time is provided by a permissioning system, wherein at least some of the control parameters of the permissioning system are specified by a user via PB manager 202. These control parameters may include, for example, an access control list populated by a user that identifies trusted users or user types. Depending upon the configuration, a user may specify that personal broadcasts may only be transmitted to and/or received from users or user types identified in the access control list. Alternatively, a user may specify that users or user types on the access control list are eligible to transmit and/or receive different personal broadcasts, personal broadcast parts, or specific personal broadcast information as compared to users or user types that are not on the access control list. These control parameters are provided by way of example only and persons skilled in the relevant art(s) will readily appreciate that other control parameters may be used.

PB manager 202 may be further configured to permit a user to provide information to personal broadcast engine 102 that is subsequently used by personal broadcast engine 102 to match the user to other users for the purpose of transmitting and/or receiving personal broadcasts. For example, PB manager 202 may be configured to request information from a user concerning particular areas of interest to the user (e.g., in the form of a questionnaire or survey). This information is then stored in user data database 212 for use in facilitating the matching of users in a manner that will be described in more detail herein.

PB manager 202 may be still further configured to allow a user to perform other management functions relating to the transmission and/or receipt of personal broadcasts via personal broadcast network 104. These management functions may include, but are not limited to, specifying one or more electronic devices associated with the user that should be eligible to receive personal broadcasts.

### 2. User Data Database 212

User data database 212 is configured to store data associated with particular users that is used by personal broadcast engine 102 to match users to each other for the purpose of transmitting and/or receiving personal broadcasts in a manner to be described in more detail herein. The user data stored in database 212 may be actively provided by a user (such as via PB manager 202), collected from user devices 110 via personal broadcast network 104 or some other channel, provided to personal broadcast engine 102 from some other network, system or database that aggregates such data, or by any combination of the foregoing. An example of a system that uses a sensor network to collect user data of the type stored in user data database 212 is described in commonly-owned, co-pending U.S. patent application Ser. No. 11/562,976, entitled “Methods, Systems and Apparatus for Delivery of Media,” the entirety of which is incorporated by reference herein.

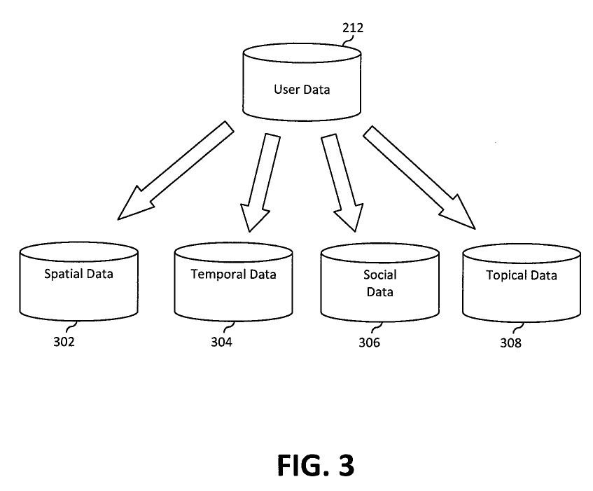

As shown in FIG. 3, the user data stored in database 212 may include spatial data 302, temporal data 304, social data 306 and topical data 308. The user data stored in database 212 may also include information deduced or derived from spatial data 302, temporal data 304, social data 306 and topical data 308, as will be discussed in more detail herein.

Spatial data 302 may be any information associated with a location of a user and/or an electronic device associated with the user. For example, spatial data 302 may include any passively-collected location data, such as cell tower data, GPRS data, global positioning service (GPS) data, WI-FI data, personal area network data, IP address data and data from other network access points, or actively-collected location data, such as location data entered into a device by a user. Spatial data 302 may also include weather data associated with various locations. Spatial data 302 may be obtained by tracking the path and state of consumer devices 110.

Temporal data 304 is time-based data (e.g., time stamps) or metadata (e.g., expiration dates) that relate to specific times and/or events associated with a user and/or an electronic device associated with the user. For example, temporal data 304 may include passively-collected time data (e.g., time data from a clock resident on an electronic device, or time data from a network clock), or actively-collected time data, such as time data entered by the user of the electronic device (e.g., a user-maintained calendar).

Social data 306 may be any data or metadata relating to the relationships of a user of an electronic device. For example, social data 306 may include user identity data, such as gender, age, race, name, social security number, photographs and other information associated with the user's identity. User identity information may also include e-mail addresses, login names and passwords. Social data 306 may also include social network data. Social network data includes data relating to any relation of the user of the electronic device that is input by a user, such as data relating to a user's friends, family, co-workers, business relations, and the like. Social network data may include, for example, data corresponding with a user-maintained electronic address book. Certain social data may be correlated with, for example, location information to deduce social network data, such as primary relationships (e.g., user-spouse, user-children and user-parent relationships) or other relationships (e.g., user-friends, user-co-worker, user-business associate relationships) and may be weighted by primacy.

Topical data 308 may be any data or metadata concerning subject matter in which a user of an electronic device appears to have an interest or is otherwise associated. Topical data 308 may be actively provided by a user (such as via PB manager 202) or may be derived from other sources.

Both social data 306 and topical data 308 may be derived from interaction data. As used herein, the term interaction data refers to any data associated with interactions carried out by a user via an electronic device, whether active or passive. Examples of interaction data include interpersonal communication data, media data, transaction data and device interaction data.

Interpersonal communication data may be any data or metadata that is received from or sent by an electronic device and that is intended as a communication to or from the user. For example, interpersonal communication data may include any data associated with an incoming or outgoing SMS message, e-mail message, voice call (e.g., a cell phone call, a voice over IP call), or other type of interpersonal communication relative to an electronic device, such as information regarding who is sending and receiving the interpersonal communication(s). As described below, interpersonal communication data may be correlated with, for example, temporal data to deduce information regarding frequency of communications, including concentrated communication patterns, which may indicate user activity information.

Media data may be any data or metadata relating to presentable media, such as audio data, visual data and audiovisual data. Audio data may be, for example, data relating to downloaded music, such as genre, artist, album and the like, and may include data regarding ringtones, ring backs, media purchased, playlists, and media shared, to name a few. Visual data may be data relating to images and/or text received by an electronic device (e.g., via the Internet or other network). Visual data may include data relating to images and/or text sent from and/or captured at an electronic device. Audiovisual data may include data or metadata associated with any videos captured at, downloaded to, or otherwise associated with an electronic device.

Media data may also include media presented to a user via a network, such as via the Internet, data relating to text entered and/or received by a user using the network (e.g., search terms), and data relating to interaction with the network media, such as click data (e.g., advertisement banner clicks, bookmarks, click patterns and the like). Thus, media data may include data relating to a user's RSS feeds, subscriptions, group memberships, game services, alerts, and the like. Media data may also include non-network activity, such as image capture and/or video capture using an electronic device, such as a mobile phone. Image data may include metadata added by a user, or other data associated with an image, such as, with respect to photos, location at which the photos were taken, direction of the shot, content of the shot, and time of day, to name a few. As described in further detail below, media data may be used for example, to deduce activities information or preferences information, such as cultural and/or buying preferences information.

Interaction data may also include transactional data or metadata. Transactional data may be any data associated with commercial transactions undertaken by a user via an electronic device, such as vendor information, financial institution information (e.g., bank information), financial account information (e.g., credit card information), merchandise information and cost/prices information, and purchase frequency information, to name a few. Transactional data may be utilized, for example, to deduce activities and preferences information. Transactional information may also be used to deduce types of devices and/or services owned by a user and/or in which a user may have an interest.

Interaction data may also include device interaction data and metadata. Device interaction data may be any data relating to a user's interaction with an electronic device not included in any of the above categories, such as data relating to habitual patterns associated with use of an electronic device. Example of device interaction data include data regarding which applications are used on an electronic system/device and how often and when those applications are used. As described in further detail below, device interaction data may be correlated with temporal data to deduce information regarding user activities and patterns associated therewith.

The user data stored in database 212 may also include deduced information. The deduced information may be deduced based on one or more of spatial data 302, temporal data 304, social data 306, or topical data 308 as described above. The deduced information may thus include information relating to deduced locations and/or deduced activities of the user. For example, the deduced information may comprise one or more of a primary user location, secondary user location, past locations, present location, and predicted future location information. The deduced information may include information deduced based on a correlation of spatial data 302 in conjunction with temporal data 304 to deduce such location data. By way of illustration, spatial data 302 may be correlated with temporal data 304 to determine that a user of an electronic device is often at one or more specific locations during certain hours of the day. In a particular embodiment, spatial data 302 is correlated with temporal data 304 to determine a primary user location (e.g., home), a secondary location (e.g., school or work) and/or other locations, as well as a cyclical model for a user's spatial/temporal patterns.

The deduced information may also include activity information, such as past activity information, present activity information, and predicted future activity information. In this regard, the past, present, or predicted future activity information may include information relating to past communications and/or co-locations with other users. By way of example, spatial data 302 may be correlated with temporal data 304 to determine a user's activities (e.g., work, recreation and/or home activities).

The deduced information may also include preferences information. The preferences information may include cultural preferences and/or buying preferences information. The cultural preferences information may be any preferences information relating to the culture of the user, such as gender preferences, ethnicity preferences, religious preferences and/or artistic preferences, to name a few. The buying preferences may be any preferences associated with the buying habits of the user. All preferences may be explicitly provided by a user or implicitly derived from aggregated user and network data.

### 3. PB Content Database

Content associated with each of the personal broadcasts eligible for distribution via personal broadcast network 104 is stored in PB content database 214. Various types of content that may be stored in PB content database 214 were described above in reference to PB manager 202 and thus will not be repeated in this section for the sake of brevity.

### 4. Exchange Rules Database

Exchange rules database 216 stores parameters that govern what type of personal broadcast information will be transmitted or received by a user, under what conditions such communication may occur, and the protocols by which such communication occurs.

Depending upon the implementation, exchange rules may be specified for specific users (user-specific exchange rules), for groups of users (group-wide exchange rules), or for all users (network-wide exchange rules). In one embodiment, group-wide exchange rules and/or network-wide exchange rules may be set up and maintained by a system administrator or other party responsible for managing personal broadcast engine 102. User-specific exchange rules may also be set up and maintained by such entities or, as described above in reference to PB manager 202, may be selected or configured by a user via PB manager 202. As further described above, such user-specific exchange rules may include, but are not limited to: rules relating to whether a user is interested in transmitting personal broadcasts only or receiving personal broadcasts only; rules relating to the number of personal broadcasts to be sent or received by a user; temporal and spatial rules relating to when and where personal broadcasts should be transmitted and received; rules relating to the type(s) of personal broadcasts the user is interested in receiving based, for example, on the origin and/or content of personal broadcasts; rules relating to users to whom personal broadcasts should be transmitted; rules relating to which personal broadcasts or personal broadcast parts are eligible for transmission to another user; and permissioning rules identifying trusted users or user types that are eligible for personal broadcasting or for the personal broadcasting of certain information.

Exchange rules 216 may also include protocols by which personal broadcast information is exchanged between users. For example, such protocols may dictate the manner in which personal information is exchanged between two users engaged in a multi-stage transaction or exchange. For example, such protocols may provide a method by which users interested in a social relationship can progressively reveal more personal information about themselves to each other. As another example, such protocols may provide a method by which a price can be negotiated between a user seeking to sell an item and a user seeking to buy such an item. However, these examples are not intended to be limiting, and other protocols governing the exchange of personal broadcast information may be used.

### 5. Matching Manager 206

Matching manager 206 is a component that is configured to determine when a user is eligible to transmit a personal broadcast to another user and/or to receive a personal broadcast therefrom. To perform this function, matching manager 206 first identifies users that are currently located within a predefined distance of each other. Matching manager 206 then performs additional tests to determine if the identified users are eligible to transmit personal broadcasts to each other, wherein such tests may be based on exchange rules applicable to the users or their personal broadcasts. If matching manager 206 determines as a result of this analysis that at least one user is eligible to send a personal broadcast to another user, it provides an identification of the user(s) and the personal broadcast(s) to be transmitted to PB exchange manager 208, which facilitates the transmission of the personal broadcast(s) and any subsequent transmissions resulting from that exchange.

To identify users that are within a predefined distance of each other, matching manager 206 may be configured to track the real-time location of each user. Matching manager 206 may track the real-time location of a user in a variety of ways. For example, matching manager 206 may track the real-time location of a user by tracking the real-time location of a user device associated with the user. The user device may be tracked using passively-collected location data, such as cell tower data, GPRS data, GPS data, WI-FI data, personal area network data, IP address data or data from other network access points, or actively-collected location data, such as location data entered into the device by the user. Such location data may be obtained from user data database 212 or from personal broadcast network 104. Matching manager 206 may also be configured to deduce or infer the location of a user from other data associated with the user.

In an alternative embodiment, matching manager 206 may be informed by a user device, network node, or other entity internal or external to personal broadcast network 104 that two or more users are currently within a predefined distance of each other and thus eligible to transmit personal broadcasts. In this instance, matching manager 206 need not track the real-time location of the users to identify them as eligible for personal broadcasting.

As noted above, once matching manager 206 has identified users that are currently located within a predefined distance of each other, matching manager 206 then applies additional tests to determine if the identified users are eligible to transmit personal broadcasts to each other, wherein such tests may be based on exchange rules applicable to the users. The types of additional tests to be performed and when they are to be applied may be controlled by user-level, group-level or network-level exchange rules stored within exchange rules database 216. Certain user-level exchange rules were described above in reference to exchange rules database 216 and thus will not be repeated in this section for the sake of brevity

The exchange rules may require matching manager 206 to analyze user data associated with each of the identified users in order to determine whether the transmission of a personal broadcast can occur. Such user data is stored in user data database 212, which was described extensively above. This feature advantageously allows matching manager 206 to match users to each other for the purpose of personal broadcasting, wherein such matching may be based on any one or more of spatial, temporal, social and topical data associated with each user. To facilitate the matching of users in this manner, matching manager 206 may maintain a graph of all users currently eligible for transmitting and receiving a personal broadcast. In one embodiment, this graph comprises a multi-dimensional graph wherein each dimension represents one variable upon which such matching may be performed.

### 6. PB Exchange Manager

PB exchange manager 208 is a component that is configured to manage the transmission of personal broadcasts to user devices 110. In particular, once matching manager 206 has authorized the transmission of a personal broadcast from a first user to a second user, PB exchange manager 208 ensures that the transmission takes place such that the personal broadcast is received on the user device associated with the second user. In one implementation, performing this function includes associating a unique identifier (ID) with the transmission, scheduling the transmission, and logging the transmission.

Based on exchange rules applicable to the users involved in the transaction, the transmission or exchange of personal broadcasts may involve a series of communications between user devices. In this instance, PB exchange manager 208 manages each communication in the series of communications. In embodiments in which a personal broadcast may include dynamic content, PB exchange manager 208 determines or resolves the dynamic content prior to transmission of the personal broadcast. Determining or resolving the dynamic content may include matching, associating and displaying advertising or sponsored content with the personal broadcast.

### 7. Communications Manager

Communications manager 210 is a component that manages all communication between personal broadcast engine 102 and consumer devices 110 residing on personal broadcast network 104. In one embodiment, communications manager 210 is used by matching manager 206 to collect real-time location information about user devices 110 for the purpose of identifying closely-located users. In a further embodiment, communications manager 210 is used by matching manager 206 to collect other information about a user for storage in user data database 212. Communications manager 210 is also used by PB exchange manager 208 to manage the transmission of personal broadcasts to user devices 110 on personal broadcast network 104. Depending upon the implementation, communications manager 210 may also be configured to interoperate with third-party carriers and networks to effect communications.

### B. Methods for Automatically Matching and Introducing Users in Accordance with Embodiments of the Present Invention

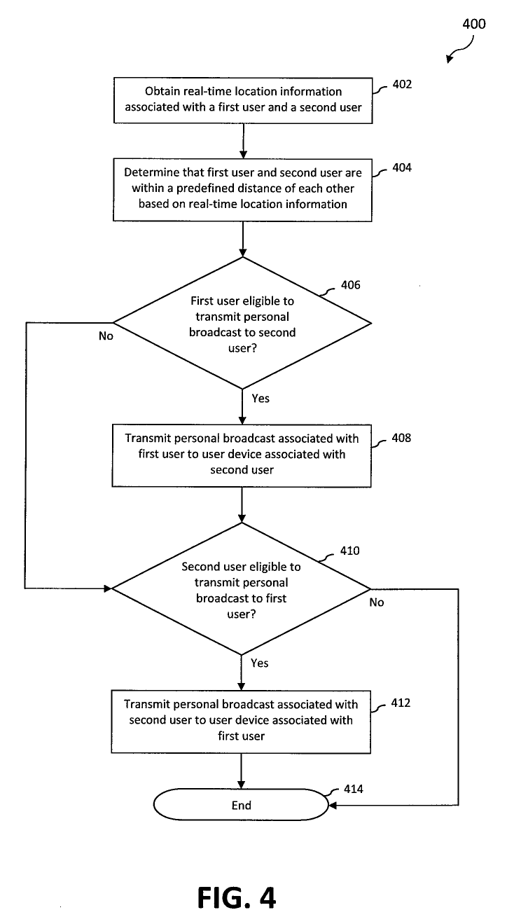

FIG. 4 depicts a flowchart 400 of a method for automatically matching and introducing users in accordance with an embodiment of the present invention. The steps of flowchart 400 will now be described with continued reference to exemplary system 100 as described above in reference to FIGS. 1 through 3, although the method is not limited to that implementation.

As shown in FIG. 4, the method of flowchart 400 begins at step 402, in which real-time location information associated with a first user and a second user is obtained. As noted above, this information may be obtained by matching manager 206 within personal broadcast engine 102. Alternatively, this information may be obtained by one or more user devices, network nodes, or other entities internal or external to personal broadcast network 104 and then transmitted to matching manager 206.

At step 404, matching manager 206 determines that the first user and the second user are within a predefined distance of each other based on the real-time location information. Depending on the implementation, this step may involve comparing location information (e.g., coordinates) associated with each of the first and second user. Alternatively, this step may comprise inferring from some other information that the first and second user are within a predefined distance of each other. For example, this step may comprise determining that user devices associated with the first and second user are present on the same wireless local area network (WLAN) or other proximity network within personal broadcast network 104 or that the users are both conducting transactions within the same commercial establishment. However, these examples are not intended to be limiting and persons skilled in the relevant art(s) will appreciate that other methods may be used to determine whether the first user and the second user are within a predefined distance of each other based on the real-time location information.

Furthermore, although step 404 is described as being performed by matching manager 206, in alternative implementations this step may be performed by a user device, network node, or other entity internal or external to personal broadcast network 104. The device, node, or entity then notifies matching manager 206 that the first user and second user are currently within a predefined distance of each other.

At decision step 406, responsive to determining that the first user and the second user are within a predefined distance of each other, matching manager 206 determines whether the first user is eligible to transmit a personal broadcast to the second user. Depending upon the implementation, this step may involve consulting exchange rules associated with the first user and/or second user, exchange rules associated with groups that include the first and/or second user, or exchange rules associated with all users.

For example, depending on the exchange rules, matching manager 206 may determine whether the first user is eligible to transmit a personal broadcast to the second user by comparing user data associated with each of the first user and the second user, wherein such user data comprises one or more of spatial, temporal, social or topical data associated with each user. Such user data is obtained by matching manager from user data database 212. Matching manager 206 can thus match users in an extremely sophisticated manner for the purpose of transmitting or sharing personal broadcasts. This matching functionality can be used, for example, to automatically broker introductions between highly-compatible users for the purpose of establishing social relationships. As will be appreciated by persons skilled in the relevant art(s), this matching functionality may also be used to automatically broker introductions between prospective sellers/buyers, employers/employees, vendors/customers, service providers/clients, or other users having some common basis for establishing a relationship.

As another example, depending on the exchange rules, matching manager 206 may determine whether the first user is eligible to transmit a personal broadcast to the second user by based on permissioning rules associated with the second user. For example, matching manager 206 may determine whether the first user is included in an access control list of trusted users or user types identified by the second user and maintained within exchange rules database 216. If the first user is not included in the access control list, then the first user cannot transmit a personal broadcast to the second user. In an alternative embodiment, matching manager 206 may authorize the transmission but PB exchange manager 208 may modify the type or amount of personal broadcast information transmitted based on whether the first user is included in the access control list. In an additional or alternative embodiment, matching manager 206 may also analyze permissioning rules associated with the first user to determine if the first user is eligible to transmit a personal broadcast to the second user.

As will be appreciated by persons skilled in the relevant art(s), numerous other exchange rules that may be applied to determine whether or not the first user is eligible to transmit a personal broadcast to the second user. Examples of such other exchange rules have been described elsewhere herein, and thus will not be described again in this section for the sake of brevity.

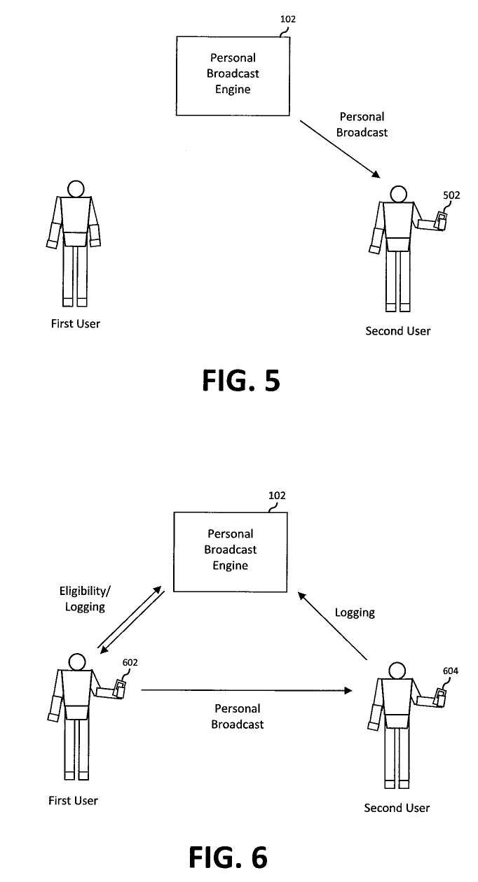

If matching manager 206 determines during decision step 406 that the first user is eligible to transmit a personal broadcast to the second user, then at step 408, PB exchange manager 208 causes a personal broadcast associated with the first user to be transmitted to a user device associated with the second user. In one embodiment of the present invention, this transmission originates from personal broadcast engine 102 and is carried over personal broadcast network 104. Such an embodiment is depicted in FIG. 5, which shows a personal broadcast being transmitted from personal broadcast engine 102 to a user device 502 associated with the second user. In one such embodiment, PB exchange manager 208 obtains the content of the personal broadcast from PB content database 214 and then transmits the content to the user device associated with the second user. This process may include formatting the content, tailoring the content to accord with exchange rules applicable to the first and/or second user, and/or inserting or resolving dynamic content (including advertising or sponsored content) associated with the personal broadcast. The manner in which the content is formatted or tailored or the manner in which dynamic content is inserted or resolved may be programmatically determined based on one or more conditions or parameters associated with the transmission of the personal broadcast, including but not limited to user data associated with the first and/or second user or other contextual data surrounding the transmission.

In an alternate embodiment, step 408 comprises transmitting a personal broadcast from a user device associated with the first user to a user device associated with the second user. Such an embodiment is depicted in FIG. 6, which shows a personal broadcast being transmitted from a user device 602 associated with a first user to a user device 604 associated with a second user. This transmission may occur over personal broadcast network 104 or via a proximity network (such as an 802.11 WLAN or Bluetooth™ piconet or scatternet) or other sub-network within personal broadcast network 104. In one such embodiment, first user device 602 stores the personal broadcast but does not transmit it to second user device 604 until personal broadcast engine sends a message to first user device 602 indicating that it is eligible to transmit. Responsive to the transmission, first user device 602 and/or second user device 604 may send information back to personal broadcast engine 102 so that personal broadcast engine 102 can log that the transaction has occurred.

If matching manager 206 determines during decision step 406 that the first user is not eligible to transmit a personal broadcast to the second user, then no such transmission occurs and step 408 is bypassed. Regardless of whether step 408 is performed, processing eventually proceeds to decision step 410 in which matching manager 206 determines whether the second user is eligible to transmit a personal broadcast to the first user. The eligibility of the second user may be determined in a like manner to that used to determine the eligibility of the first user to transmit a personal broadcast to the second user, as described above in reference to decision step 406. Thus, a description of this process need not be repeated here.

If matching manager 206 determines during decision step 410 that the second user is eligible to transmit a personal broadcast to the first user, then at step 412, PB exchange manager 208 causes a personal broadcast associated with the second user to be transmitted to a user device associated with the second user. In one embodiment of the present invention, this transmission originates from personal broadcast engine 102 and is carried over personal broadcast network 104. In an alternate embodiment, step 412 comprises transmitting a personal broadcast from a user device associated with the second user to a user device associated with the first user.

If matching manager 206 determines during decision step 410 that the second user is not eligible to transmit a personal broadcast to the first user, then no such transmission occurs and step 412 is bypassed. Regardless of whether step 412 is performed, processing eventually ends at step 414.

Although the method of flowchart 400 describes the potential exchange of personal broadcasts by two users, the present invention is not so limited and may encompass the exchange of personal broadcasts between any number of proximally-located users. The necessary extension of the method of flowchart 400 to encompass such additional transmissions or exchanges is well within the skill of persons skilled in the relevant art(s).

Furthermore, the method of flowchart 400 presumes that each of the first user and the second user are carrying an associated user device capable of receiving a personal broadcast. However, the present invention also encompasses a scenario in which only a single user of the pair is carrying a user device and is thus capable of receiving a personal broadcast.

Additionally, the method of flowchart 400 describes only the potential transmission of a single personal broadcast from a first user to a second user and the potential transmission of a single personal broadcast from the second user to the first user. However, in accordance with an embodiment of the present invention, multiple personal broadcasts may be transmitted from one user to another proximally-located user.

Furthermore, although it is not shown in flowchart 400 of FIG. 4, the transmission of a personal broadcast may begin a multi-stage transaction between two users. In one implementation, the multi-stage transaction is managed by PB exchange manager 208 in accordance with protocols stored in exchange rules database 216. As noted above, such protocols may provide, for example, a method by which users interested in a social relationship can progressively reveal more personal information about themselves to each other or by which a price can be negotiated between a user seeking to sell an item and a user seeking to buy such an item. However, these examples are not intended to be limiting, and other protocols governing the exchange of personal broadcast information may be used.

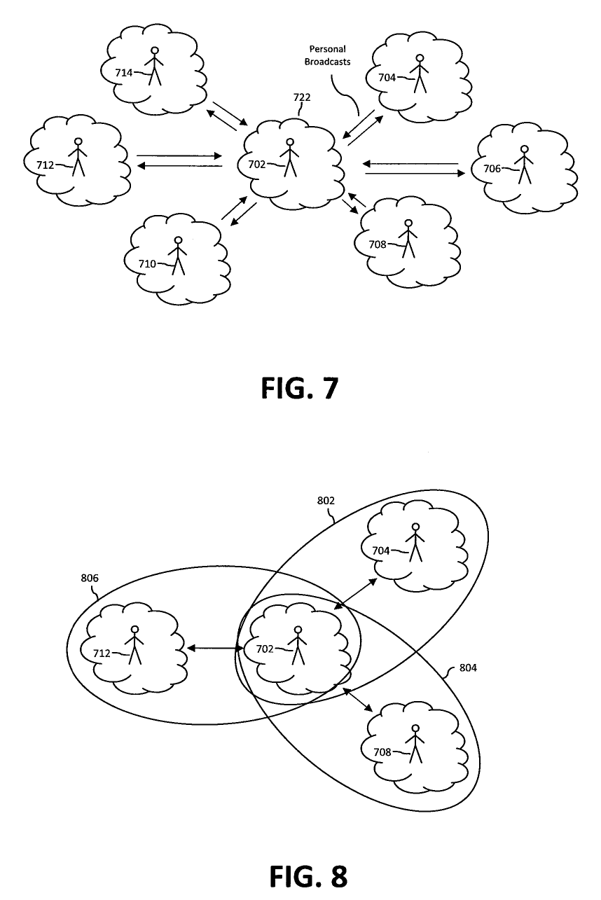

The foregoing method of flowchart 400, and extensions thereof, advantageously provides a way of matching and introducing users based on their real-time locations, such that users identified as capable of or likely to form a relationship can be notified of that fact at a point in time when it is easy to meet. A conceptual representation of this is depicted in FIG. 7, which shows a plurality of users 702, 704, 706, 708, 710, 712 and 714 carrying devices that are capable of receiving personal broadcasts. Each user is surrounded by a “personal broadcast cloud,” which is intended to represent the area around the user in which personal broadcasts may be transmitted and/or received by the user, as monitored by personal broadcast engine 102. For example, user 702 is surrounded by personal broadcast cloud 722.

When personal broadcast clouds intersect, personal broadcasts may be transmitted between users, as shown in FIG. 7. It is noted that although the actual intersection of the clouds is not shown in FIG. 7, such intersection is implied by the arrows indicating the transmission of personal broadcasts between the users. This transmission of personal broadcasts may occur between personal broadcast engine 102 and a user device or between user devices, as discussed above in reference to FIGS. 5 and 6. Physically, the transmission may take place via any available communication network and/or channel, including but not limited to the Internet, an 802.11 WLAN, a Bluetooth™ piconet or scatternet, or some other network or channel. These networks and/or channels are considered part of personal broadcast network 104.

Should data be exchanged between the users beyond an initial personal broadcast then, logically speaking, an exchange cloud is formed between or around the users. This is depicted in FIG. 8. As shown in that figure, an exchange cloud 802 has been formed around user 702 and user 704, an exchange cloud 804 has been formed around user 702 and user 708, and an exchange cloud 806 has been formed around user 702 and user 712. The formation of an exchange cloud may occur, for example, when two users that receive personal broadcasts from each other decide to engage in one or more further electronic transactions with each other. Each exchange cloud may thus represent the additional data exchange as well as the medium used to carry it. The formation of an exchange cloud may also be an event that is observed by personal broadcast engine 102 for the purpose of automatically initiating additional communications or services, or for recording or logging transactions between the users.

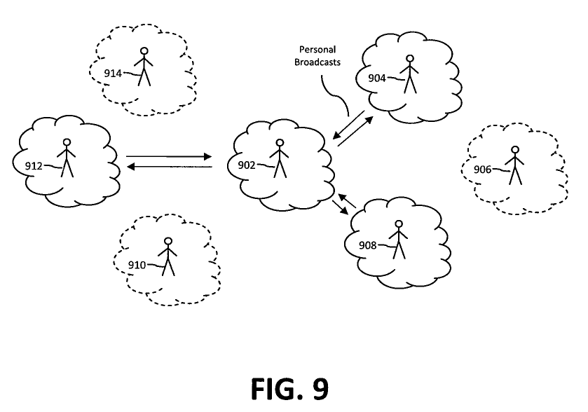

By filtering which personal broadcasts may be transmitted and/or received by a user, an embodiment of the present invention supports “selective visibility” of users and their associated personal broadcasts. This concept is represented in FIG. 9, which depicts a user 902 whose personal broadcast cloud intersects with personal broadcast clouds associated with users 904, 906, 908, 910, 912 and 914. However, due to a filtering function performed by personal broadcast engine 102, only users 904, 908 and 912 are capable of transmitting and/or receiving personal broadcasts to/from user 902. Thus, these are the only users that are “visible” to user 902 for the purposes of personal broadcasting.

The filtering function performed by personal broadcast engine 102 may be based, for example, on the compatibility of users as determined by matching manager 206, such that the only users visible are those with whom one is likely to form a social relationship. Compatibility may be based on user-defined parameters, system-defined parameters, or a combination of both. The filtering function may also be based on a matching of users selling or providing items or services to users seeking such items or services, such that the only users visible are those with whom one is likely to form a business or commercial relationship. The filtering function may further be based on a permissioning system that screens out users or user types not identified as trusted, such that only trusted users are visible, or based on a “spam”-filtering system that screens out undesired “spam” broadcasts. A further example implementation makes only existing friends or social network members visible while another example implementation makes only users who are not existing friends or social network members visible. Thus, selective visibility provides a means to limit the personal broadcasts transmitted or received by a user and can advantageously be used to target selected users or user types, manage the volume of transactions with other users, and protect user privacy.

### C. Real-Place, Different-Time Matching and Introducing of Users in Accordance with Embodiments of the Present Invention

As discussed above, an embodiment of the present invention facilitates introductions between users based on their real-time locations, such that users identified as capable of or likely to form a relationship can be notified of that fact at a point in time when it is easy to meet. However, the above-mentioned embodiments do not address a scenario in which two users who are capable of or likely to form a relationship visit or pass through the same location but at different points in time. An embodiment of the present invention allows at least one of these two users to automatically receive information about the other despite the temporal separation between them.

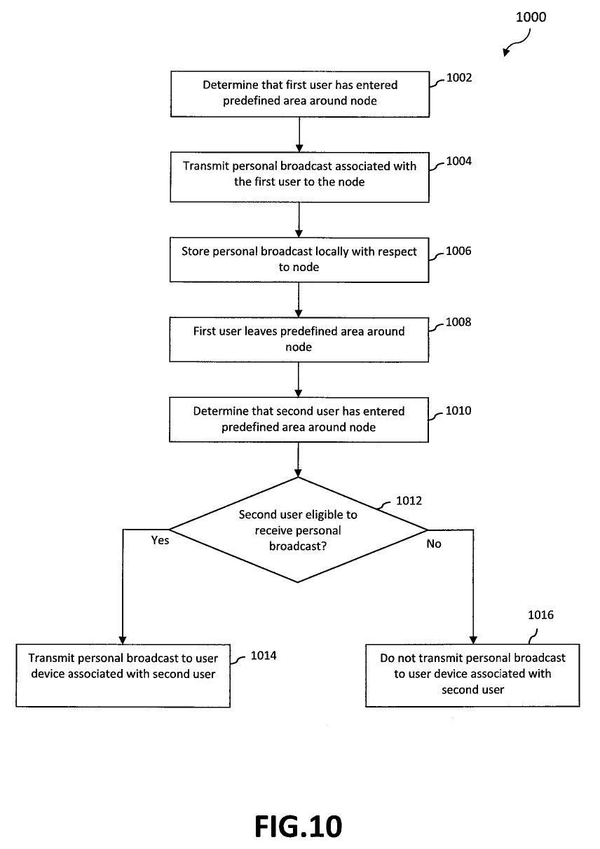

This embodiment will now be described in reference to flowchart 1000 of FIG. 10. As shown in FIG. 10, the method of flowchart 1000 begins at step 1002, in which it is determined that a first user has entered a predefined area around a node. The node may comprise, for example, a network node within personal broadcast network 104. In one embodiment, the network node is an 802.11 wireless access point, although the invention is not so limited.

The determination that the first user has entered the predefined area around the node may be made by personal broadcast engine 102 using any of the real-time location tracking methods or information described elsewhere herein. Alternatively, the determination of whether the first user has entered the predefined area around the node may be made by the node itself. For example, the node may determine that the first user has entered the predefined area by obtaining real-time location tracking information about the first user. As another example, the node may determine that the first user has entered the predefined area by detecting the presence of a user device associated with the first user on a proximity network or other sub-network managed by the node.

At step 1004, responsive to determining that the first user has entered the predefined area around the node, a personal broadcast associated with the first user is transmitted to the node. The personal broadcast may be transmitted from personal broadcast engine 102 to the node or, alternatively, from a user device carried by the first user to the node. In the latter case, either the user device associated with the first user and/or the node may notify personal broadcast engine 102 that the transmission has occurred so that personal broadcast engine 102 may log or otherwise track the transmission. This step may also include determining that the first user is eligible to transmit a personal broadcast to the node.

At step 1006, the node receives and stores the personal broadcast locally. Storing the personal broadcast locally may include storing the personal broadcast in a memory system or device integral to or connected to the node.

At step 1008, the first user leaves the predefined area around the node.

At step 1010, at a time subsequent to the first user leaving the predefined area around the node, it is determined that a second user has entered the predefined area around the node. The determination that the second user has entered the predefined area around the node may be made by personal broadcast engine 102 or by the node itself. This determination may be made in a like manner to the manner in which it was determined that the first user entered the predefined area around the node as described above in reference to step 1002.

At decision step 1012, responsive to the determination that the second user has entered the predefined area around the node, a decision is made concerning whether the second user is eligible to receive the personal broadcast that was stored locally with respect to the node in step 1006. This step may include performing any of the matching functions or applying any of the exchange rules described above in reference to personal broadcast engine 102 of FIG. 1. This step may be performed by personal broadcast engine 102, with the result communicated to the node, or may be performed by similarly-configured logic within the node itself.

If it is determined during decision step 1012 that the second user is eligible to receive the personal broadcast, then the personal broadcast is transmitted from the node to a user device associated with the second user as shown at step 1014. If, however, it is determined during decision step 1012 the second user is not eligible to receive the personal broadcast, then the personal broadcast is not transmitted from the node to the user device associated with the second user as shown at step 1016.

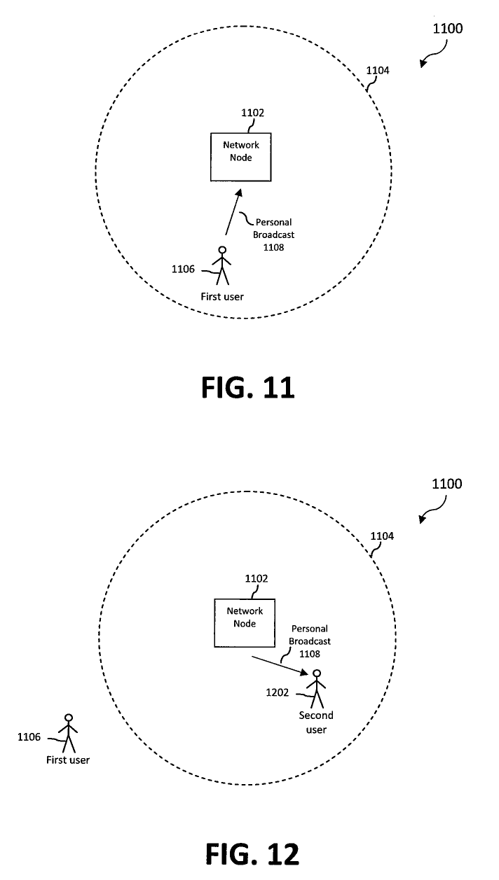

Aspects of the foregoing method are illustrated in FIGS. 11 and 12. In particular, FIG. 11 shows a system 1100 that includes a network node 1102, wherein network node 1102 is intended to represent one of a plurality of network nodes within personal broadcast network 104. As further shown in FIG. 11, a first user 1106 has entered into a predefined area 1104 around network node 1102. Responsive to first user 1106 entering predefined area 1104, a personal broadcast 1108 associated with first user 1106 is transmitted to network node 1102, where it is stored locally.

FIG. 12 depicts the same system 1100 at a later point in time when first user 1106 has left predefined area 1104 and a second user 1202 has entered predefined area 1104. Responsive to second user 1202 entering predefined area 1104, network node 1102 determines whether second user 1202 is eligible to receive personal broadcast 1108, which has remained in local storage with respect to network node 1102. Responsive to determining that second user 1202 is eligible, personal broadcast 1108 is transmitted to a user device associated with second user 1202.

The foregoing method may advantageously be used to connect or broker introductions between users that enter or pass through the same area or space but at different points in time. It is not uncommon for users with like interests or profiles to attend or frequent the same business establishments, recreational areas, events or attractions. However such users may not attend or frequent those locations at the same time. In accordance with the foregoing method, a network node can advantageously be used to store personal broadcasts in order to bridge the temporal gap between such users. The amount of time that such personal broadcasts may be stored may vary depending upon the implementation.

### D. Use of Node-Based Event Clouds in Accordance with an Embodiment of the Present Invention

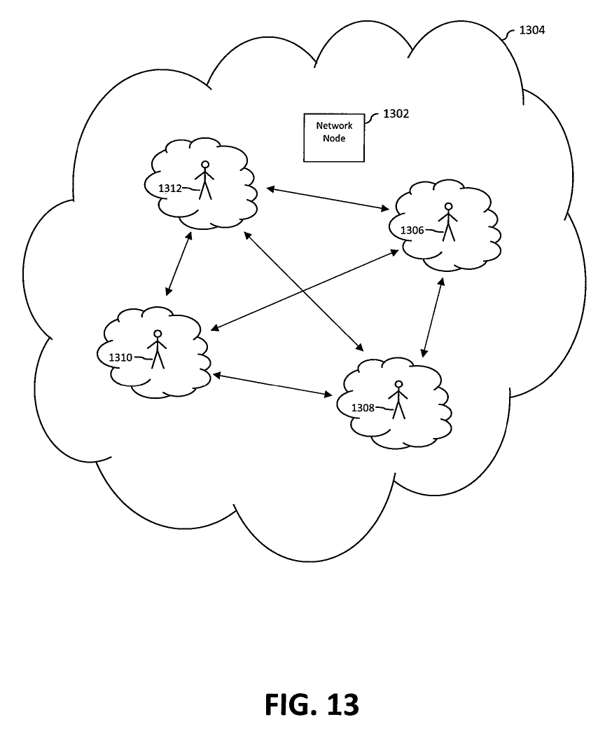

In an alternate embodiment of the present invention, a network node within personal broadcast network 104 may be used to automatically create exchange clouds among all users registered with or detected by the network node. FIG. 13 depicts a system 1300 in accordance with such an embodiment. As shown in FIG. 13, system 1300 includes a network node 1302. Network node 1302 manages a sub-network 1304 within personal broadcast network 104. In one embodiment of the present invention, network node 1302 comprises a wireless access point and sub-network 1304 is an 802.11 WLAN, although the invention is not so limited.

In system 1300, each of a plurality of users 1306, 1308, 1310 and 1312 is carrying a user device that is connected to or otherwise detectable on sub-network 1304. By virtue of their presence on sub-network 1304, each user is automatically capable of exchanging personal broadcast information with the other users via their user devices. The exchange of personal broadcast information is facilitated and optionally controlled by network node 1302. For example, network node 1302 may perform any of the matching functions or applying any of the exchange rules described above in reference to personal broadcast engine 102 of FIG. 1 prior to allowing personal broadcast information to be transmitted or exchanged between users. In an alternate implementation, network node 1302 communicates with personal broadcast engine 102, which performs the matching functions and/or applies the exchange rules. User participation in exchanging personal broadcast information can be public (i.e., visible to all other users within sub-network 1304) or private depending on preferences set by the owner/administrator of network node 1302 and/or by the users themselves.

A system such as that described above in reference to FIG. 13 may be advantageously used to create personal broadcasting environments around a particular location or event. For example, such a system may be used to create personal broadcasting environments around commercial establishments or events (e.g., stores, malls, restaurants, bars, coffee shops, product expositions, flea markets, swap meets), social gatherings or events (e.g., concerts, block parties), sports or athletic events (e.g., football games, triathlons, races), community meetings or events (e.g., town hall meetings), academic, professional or business conferences, or any other establishment, venue, event or activity which may be attended by multiple people. Such environments may be thought of conceptually as “location clouds” or “event clouds.”

### E. Asynchronous Reporting of User Information in Accordance with an Embodiment of the Present Invention

As described above, an embodiment of the present invention allows personal broadcast information to be selectively exchanged among proximally-located users (or users that have entered into or passed through the same area but at different times) for the purpose of facilitating introductions and the building of relationships between such users. In an alternate embodiment of the present invention, similar methods are used to support the asynchronous reporting of information to a first user about other users that the first user encounters or comes into contact with during the course of a day.

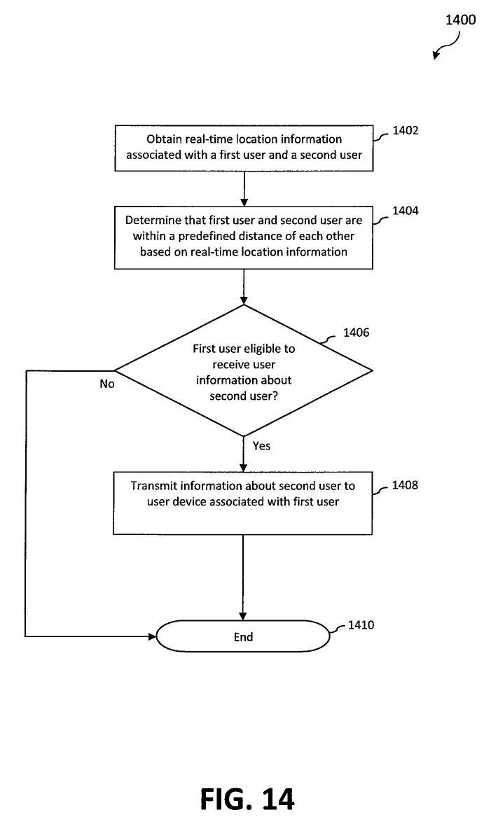

Such an embodiment will now be described in reference to flowchart 1400 of FIG. 14. As shown in FIG. 14, the method of flowchart 1400 begins at step 1402, in which real-time location information associated with a first user and a second user is obtained. As noted above, this information may be obtained by matching manager 206 within personal broadcast engine 102. Alternatively, this information may be obtained by one or more user devices, network nodes, or other entities internal or external to personal broadcast network 104 and then transmitted to matching manager 206.

At step 1404, matching manager 206 determines that the first user and the second user are within a predefined distance of each other based on the real-time location information. Depending on the implementation, this step may involve comparing location information (e.g., coordinates) associated with each of the first and second user. Alternatively, this step may comprise inferring from some other information that the first and second user are within a predefined distance of each other. Furthermore, although step 1404 is described as being performed by matching manager 206, in alternative implementations this step may be performed by a user device, network node, or other entity internal or external to personal broadcast network 104. The device, node, or entity then notifies matching manager 206 that the first user and second user are currently within a predefined distance of each other.

At decision step 1406, responsive to determining that the first user and the second user are within a predefined distance of each other, matching manager 206 determines whether the first user is eligible to receive user information about the second user. Depending upon the implementation, this step may involve consulting exchange rules associated with the first user and/or second user, exchange rules associated with groups that include the first and/or second user, or exchange rules associated with all users.

If matching manager 206 determines during decision step 1406 that the first user is eligible to receive user information about the second user, then at step 1408, PB exchange manager 208 causes user information associated with the second user to be transmitted to a user device associated with the first user. In one embodiment of the present invention, this transmission originates from personal broadcast engine 102 and is carried over personal broadcast network 104. In an alternate embodiment, step 1408 comprises transmitting the user information from a user device associated with the second user to a user device associated with the first user.

If matching manager 206 determines during decision step 1406 that the second user is not eligible to receive user information about the second user, then no such transmission occurs and step 1408 is bypassed. Regardless of whether step 1408 is performed, processing eventually ends at step 1410.

The foregoing method of flowchart 1400, and extensions thereof, advantageously provides a way of providing users with information about other users around them in a manner that need not initiate an exchange or interaction with the other user. This method can be used, for example, to provide a user entering a particular area or location with a report concerning all or a selected portion of the other users in that area and their relatedness to the user. Relatedness may be measured and optionally sorted along one or more dimensions or variables associated with a user or user profile. Such an embodiment could also report unique or queried shared attributes among users in a particular area or location. The provision of such a report could be user-initiated, user-device initiated, or network-initiated.

Such passive, “observer-only” type reports need not facilitate the formation of exchange clouds between users, and thus the observed users need not be impacted. For example, in accordance with such an embodiment, a user could transmit a request to personal broadcast engine 102 to count how many owners of a particular type of car the user passes in a day. Responsive to the request, matching manager 206 would provide a user device associated with the user with the requested information. However, the users so counted need not be aware that they have been counted. Of course, depending upon the implementation, options could be provided by which observed users must authorize the release of any user information and by which an observed user could be notified of the transmission of any user information to another user.

In an extension of this method, personal broadcast engine 102 could automatically provide a first and second user with selected information about the other based on a determination that the first and second users are highly-compatible. Personal broadcast engine 102 could further solicit feedback from the first and second users concerning their desire to be introduced to each other. Personal broadcast engine 102 would then only create a mutual introduction if both the first and second user indicated an interest for continued mediated communication. In accordance with such an embodiment, personal broadcast engine 102 acts as both matchmaker and chaperone in providing not only an introduction but ongoing feedback to the dating process.

### F. Example Applications of Personal Broadcast Engine and Network

A personal broadcast engine and network as described herein can be used to support a variety of useful applications and services. For example, as previously discussed, the personal broadcast engine and network can be used to facilitate introductions between highly-compatible users for the purpose of establishing social relationships. Thus, for example, the personal broadcast engine and network could be used to support a dating or matchmaking service, or a service that distributes personal ads. As also discussed above, a personal broadcast engine and network may also be used to facilitate introductions between prospective sellers/buyers, employers/employees, vendors/customers, service providers/clients, and thus can be used to provide a variety of commerce-related services as well. These commerce-related services may include, for example, a service that publishes resumes, help-wanted advertisements, or classified advertisements.

Another potential application of a personal broadcast engine and network is in facilitating games or other interactive events that require or encourage proximally-located users to share information between their user devices, or between user devices and network nodes. Such games may be used, for example, to entertain, introduce users, to teach, or to promote a product, service or event. Such games may include role-playing games in which personal broadcasts are used to convey information about a role played by a user. Such games may also support fictional or non-player characters, wherein personal broadcast information associated with such fictional or non-player characters is transmitted by a personal broadcast engine or a network node within a personal broadcast network.

A personal broadcast engine and network as described herein may further be used for applications dealing with personal/public safety and security. For example, such a personal broadcast network may be used for rapid proximity-based distribution of any type of alert, warning or notification among users carrying personal broadcast-enabled user devices.

As another example, personal broadcasts could be used to notify other proximally-located users when the user with whom the personal broadcast is associated is in need of help or medical assistance. A determination as to which users should be notified could be made based on relationship (for example, in an embodiment where the user in need of help is a lost child, it may be that only trusted friends and family can be notified) or based on the profession or capabilities of the recipient (for example, in an embodiment where the user is in need of medical assistance, it may be that only doctors, nurses or paramedics can be notified). The issuance of such a personal broadcast may be initiated by a user or may be initiated in response to automatically-tracked data, such as biometric data associated with a user, that indicates that the user may be in need of help.

In another embodiment, personal broadcasts may be used to carry vital information about a user that can be transmitted to other users in a situation in which the user is incapable of conveying such information themselves. Such information may include medical information including but not limited to a list of current and/or past medical problems, medical and surgical history, childbirth history, current medications, allergies, family medical history, organ donor information and/or emergency contact information.

The foregoing applications have been described herein by way of example only and are not intended to limit the present invention. Persons skilled in the relevant art(s) will readily appreciate that the personal broadcast engine and network as described herein can also be used to support a variety of other useful applications and services beyond those described herein.

### G. Implementation Variations and Extensions

In accordance with one embodiment of the present invention, the transmission of a personal broadcast from a first user to a second user may be made dependent upon a changing condition associated with the second user, such that the personal broadcast is not transmitted from the first user to the second user until after the users are no longer proximally located. For example, the first user may be interested in dating the second user, but the second user's profile may indicate that the second user is currently in a relationship. In accordance with such an embodiment, the first user may request that a personal broadcast be delayed until the second user's profile changes to indicate that the second user is no longer in a relationship.

In another embodiment of the present invention, personal broadcasts may be transmitted to users based on parameters that do not include the real-time location of a user. For example, personal broadcasts may be transmitted to or propagated among users within a particular social network.

In a further embodiment of the present invention, the transmission and/or exchange of personal broadcast information is tracked by the personal broadcast engine and analyzed to identify matchmaking trends among a large user base. The data from this analysis can be used to populate a series of compatibility vectors based upon cluster of any of wide variety of indicators.

In a still further embodiment of the present invention, personal broadcasts are configured to carry advertising content or other sponsored content. Advertisers may thus become sponsors of personal broadcasts. Such content may be static or dynamically-generated at the time of broadcast. Revenue from such advertising or sponsorship may be used to subsidize or carry the costs of the personal broadcasting system. Furthermore, any revenue derived from such advertising or sponsorship could also be shared with the users or node operators. In one embodiment, the advertising or sponsored content is targeted to the sender and/or recipient of the personal broadcast. This targeting may be based on the same user data that is used to match users for the purpose of personal broadcasting.

In yet another embodiment of the present invention, personal broadcasts are logged and the content of the personal broadcasts are analyzed to obtain additional information useful for profiling and matching users. For example, entity extraction may be performed to help isolate or identify information or strings located within personal broadcasts that are useful for profiling or matching users.

### H. Example Computer System Implementation

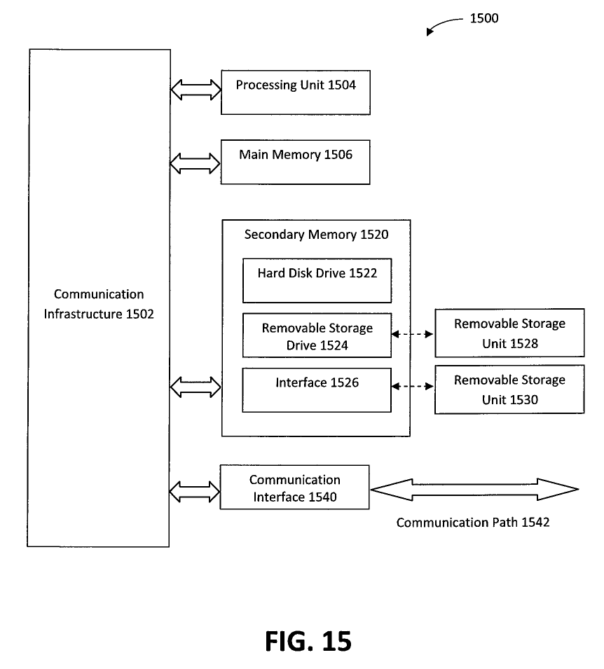

Each of the components of a personal broadcast engine in accordance with an embodiment of the present invention (such as personal broadcast engine 102 described above in reference to FIGS. 1 and 2) may be implemented alone or in combination by any well-known processor-based computer system. Likewise, each of the user devices and network nodes described herein may be implemented by any well known processor-based computer system. An example of such a computer system 1500 is depicted in FIG. 15.

As shown in FIG. 15, computer system 1500 includes a processing unit 1504 that includes one or more processors. Processor unit 1504 is connected to a communication infrastructure 1502, which may comprise, for example, a bus or a network.

Computer system 1500 also includes a main memory 1506, preferably random access memory (RAM), and may also include a secondary memory 1520. Secondary memory 1520 may include, for example, a hard disk drive 1522, a removable storage drive 1524, and/or a memory stick. Removable storage drive 1524 may comprise a floppy disk drive, a magnetic tape drive, an optical disk drive, a flash memory, or the like. Removable storage drive 1524 reads from and/or writes to a removable storage unit 1528 in a well-known manner. Removable storage unit 1528 may comprise a floppy disk, magnetic tape, optical disk, or the like, which is read by and written to by removable storage drive 1524. As will be appreciated by persons skilled in the relevant art(s), removable storage unit 1528 includes a computer usable storage medium having stored therein computer software and/or data.

In alternative implementations, secondary memory 1520 may include other similar means for allowing computer programs or other instructions to be loaded into computer system 1500. Such means may include, for example, a removable storage unit 1530 and an interface 1526. Examples of such means may include a program cartridge and cartridge interface (such as that found in video game devices), a removable memory chip (such as an EPROM, or PROM) and associated socket, and other removable storage units 1530 and interfaces 1526 which allow software and data to be transferred from the removable storage unit 1530 to computer system 1500.

Computer system 1500 may also include a communications interface 1540. Communications interface 1540 allows software and data to be transferred between computer system 1500 and external devices. Examples of communications interface 1540 may include a modem, a network interface (such as an Ethernet card), a communications port, a PCMCIA slot and card, or the like. Software and data transferred via communications interface 1540 are in the form of signals which may be electronic, electromagnetic, optical, or other signals capable of being received by communications interface 1540. These signals are provided to communications interface 1540 via a communications path 1542. Communications path 1542 carries signals and may be implemented using wire or cable, fiber optics, a phone line, a cellular phone link, an RF link and other communications channels.

As used herein, the terms “computer program medium” and “computer usable medium” are used to generally refer to media such as removable storage unit 1528, removable storage unit 1530, a hard disk installed in hard disk drive 1522, and signals received by communications interface 1540. Computer program medium and computer useable medium can also refer to memories, such as main memory 1506 and secondary memory 1520, which can be semiconductor devices (e.g., DRAMs, etc.). These computer program products are means for providing software to computer system 1500.

Computer programs (also called computer control logic, programming logic, or logic) are stored in main memory 1506 and/or secondary memory 1520. Computer programs may also be received via communications interface 1540. Such computer programs, when executed, enable the computer system 1500 to implement features of the present invention as discussed herein. Accordingly, such computer programs represent controllers of the computer system 1500. Where the invention is implemented using software, the software may be stored in a computer program product and loaded into computer system 1500 using removable storage drive 1524, interface 1526, or communications interface 1540.

The invention is also directed to computer program products comprising software stored on any computer useable medium. Such software, when executed in one or more data processing devices, causes a data processing device(s) to operate as described herein. Embodiments of the present invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, zip disks, tapes, magnetic storage devices, optical storage devices, MEMs, nanotechnology-based storage device, etc.), and communication mediums (e.g., wired and wireless communication networks, local area networks, wide area networks, intranets, etc.).

### H. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for matching and introducing users, comprising:
determining that a first user and a second user are within a predefined distance of each other based on real-time location information associated with the first user and the second user;
responsive to determining that the first user and the second user are within a predefined distance of each other, determining if the first user is eligible to transmit a personal broadcast to the second user; and
responsive to determining that the first user is eligible to transmit a personal broadcast to the second user, transmitting a personal broadcast associated with the first user to a user device associated with the second user over a network.

2. The method of claim 1, wherein the personal broadcast comprises one of:
a user profile;
a business card;
a classified advertisement;
a personals advertisement;
a resume; or
a help wanted posting.

3. The method of claim 1, further comprising obtaining the location-tracking information associated with the first user and the second user by tracking the location of a user device associated with the first user and the user device associated with the second user.

4. The method of claim 1, wherein determining if the first user is eligible to transmit a personal broadcast to the second user comprises comparing user data associated with the first user and user data associated with the second user, wherein the user data comprises one or more of spatial, temporal, social or topical data associated with each user.

5. The method of claim 1, wherein determining if the first user is eligible to transmit a personal broadcast to the second user comprises accessing permissioning rules associated with the first and/or second user.

6. The method of claim 1, further comprising:
inserting dynamic content within the personal broadcast prior to transmitting the personal broadcast, wherein the dynamic content is programmatically-determined based on one or more conditions associated with the transmission of the personal broadcast from the first user to the second user.

7. The method of claim 6, wherein the dynamic content comprises an advertisement or sponsored content associated with the personal broadcast.

8. The method of claim 1, further comprising:
receiving a personal broadcast associated with the second user by a user device associated with a first user over the network.

9. A system for matching and introducing users, comprising:
a matching manager configured to determine that a first user and a second user are within a predefined distance of each other based on real-time location information associated with the first user and the second user and, responsive to determining that the first user and the second user are within a predefined distance of each other, to determine if the first user is eligible to transmit a personal broadcast to the second user; and
a personal broadcast exchange manager communicatively connected to the matching manager, the personal broadcast exchange manager configured to transmit a personal broadcast associated with the first user to a user device associated with the second user over a network responsive to a determination that the first user is eligible to transmit a personal broadcast to the second user.

10. The system of claim 9, wherein the personal broadcast comprises one of:
a user profile;
a business card;
a classified advertisement;
a personals advertisement;
a resume; or
a help wanted posting.

11. The system of claim 9, wherein the matching manager is configured to obtain the location-tracking information associated with the first user and the second user by tracking the location of a user device associated with the first user and the user device associated with the second user.

12. The system of claim 9, wherein the matching manager is configured to determine if the first user is eligible to transmit a personal broadcast to the second user by comparing user data associated with the first user and user data associated with the second user, wherein the user data comprises one or more of spatial, temporal, social or topical data associated with each user.

13. The system of claim 9, wherein the matching manager is configured to determine if the first user is eligible to transmit a personal broadcast to the second user by accessing permissioning rules associated with the first and/or second user.

14. The system of claim 9, wherein the personal broadcast exchange manager is further configured to insert dynamic content within the personal broadcast prior to transmitting the personal broadcast, wherein the dynamic content is programmatically-determined based on one or more conditions associated with the transmission of the personal broadcast from the first user to the second user.

15. The system of claim 14, wherein the dynamic content comprises an advertisement or sponsored content associated with the personal broadcast.

16. The system of claim 9, further comprising:
a personal broadcast manager configured to permit a remote user to select and/or generate content associated with a personal broadcast.

17. A method for matching and introducing users, comprising:
transmitting a personal broadcast associated with a first user to a network node responsive to determining that the first user has entered a predefined area around the network node;
storing the personal broadcast locally with respect to the network node; and
transmitting the personal broadcast from the network node to a user device associated with a second user responsive to determining that the second user has entered the predefined area around the network node;
wherein the second transmitting step occurs after the first user has left the predefined area around the network node.

18. The method of claim 17, further comprising determining if the second user is eligible to receive the personal broadcast.

19. The method of claim 18, wherein determining if the second user is eligible to receive the personal broadcast comprises comparing user data associated with the first user and user data associated with the second user, wherein the user data comprises one or more of spatial, temporal, social or topical data associated with each user.

20. The method of claim 18, wherein determining if the second user is eligible to receive the personal broadcast comprises accessing permissioning rules associated with the first and/or second user

21. A system for matching and introducing users, comprising:
a personal broadcast engine; and
a network node communicatively connected to the personal broadcast engine;
wherein the personal broadcast engine is configured to transmit a personal broadcast associated with a first user to the network node responsive to determining that the first user has entered a predefined area around the network node, and
wherein the network node is configured to store the personal broadcast and to subsequently transmit the personal broadcast to a user device associated with a second user responsive to determining that the second user has entered the predefined area around the network node.

22. The system of claim 21, wherein the network node is further configured to determine if the second user is eligible to receive the personal broadcast.

23. The system of claim 22, wherein the network node is configured to determine if the second user is eligible to receive the personal broadcast by comparing user data associated with the first user and user data associated with the second user, wherein the user data comprises one or more of spatial, temporal, social or topical data associated with each user.

24. The system of claim 22, wherein the network node is configured to determine if the second user is eligible to receive the personal broadcast by accessing permissioning rules associated with the first and/or second user.
